(19) United States
(12) Patent Application Publication
(10) Pub. No.: US 2004/0126051 A1
(43) Pub. Date: Jul. 1, 2004

(54) Low-birefringent integrated optics structures

(76) Inventor: Michel Bruel, Veurey (FR)

Correspondence Address: BURNS DOANE SWECKER & MATHIS L L P, POST OFFICE BOX 1404, ALEXANDRIA, VA, 22313-1404, US

(21) Appl. No.: 10/470,191

(22) PCT Filed: Jan. 24, 2002
(86) PCT No.: PCT/FR02/00298

(30) Foreign Application Priority Data
Jan. 25, 2001 (FR) 01/01016

(51) Int. Cl. G02B 6/12

(52) U.S. Cl. 385/14

(57) ABSTRACT

A multiplayer integrated optical structure includes an integrated optical microguide having an integrated core for transmitting at least a light wave. A gap extends along the transmission core and encloses at least part of its periphery. This gap is filled with a material whose elasticity or deformability are higher than those of the lower layer and those of the upper layer of the core. Thus, the stresses and/or possible deformations of the core can be eliminated or reduced.

The present invention relates to the field of the transmission of optical or light waves in integrated optics microguide optical guiding structures.

Known integrated optics structures usually comprise a light wave transmission core formed between two layers, the refractive index of the constituent material of the core being higher than the refractive index of the constituent material or materials of these layers. In general, these layers are made of undoped silica and the transmission cores are made of doped silica, of silicon nitride or of silicon oxynitride.

It has been observed that the optical wave transmitted in the transmission cores of such structures undergo a birefringence effect, that is to say a deformation of the index ellipsoid. It has also been observed that all or some of this birefringence is due to the existence of strains in the transmission core or in the layers surrounding it, said strains being produced during the fabrication of the structure, or else due to the creation of strains during the use of the structures.

The object of the present invention is in particular to propose an integrated optics structure in which the transmitted light wave is not subjected to a birefringence effect or, at the very least, is subjected only to a slight birefringence effect.

The multilayer integrated optics structure according to the present invention, which comprises at least one integrated optics microguide having an integrated core for the transmission of at least one light wave, is such that a gap runs along said transmission core and at least partly surrounds its periphery.

According to the present invention, said gap may advantageously completely surround said transmission core.

According to the present invention, said gap is preferably at least partly filled with a material whose elasticity or whose deformability are greater than those of the layer or layers adjacent said transmission core.

According to the present invention, said transmission core is preferably produced on an intermediate layer and in a following layer, this intermediate layer exhibiting greater elasticity or deformability than this following layer and/or the layer on which it is formed.

According to the present invention, said transmission core is preferably produced between two layers and on one of these layers and that a strip exhibiting greater elasticity or deformability than at least one of these layers is interposed between one of these layers and the transmission core.

According to the present invention, said gap may advantageously be left between at least one intermediate strip and said transmission core.

According to the present invention, said intermediate strip is preferably produced laterally to said transmission core.

According to the present invention, the thickness of said gap is preferably less than the wavelength of the light wave transmitted via said transmission core.

According to the present invention, said transmission core is preferably of rectangular cross section, said gap preferably extending along at least one of its sides.

The present invention will be more clearly understood on studying the various integrated optics structures described by way of nonlimiting examples and illustrated by the drawing in which:

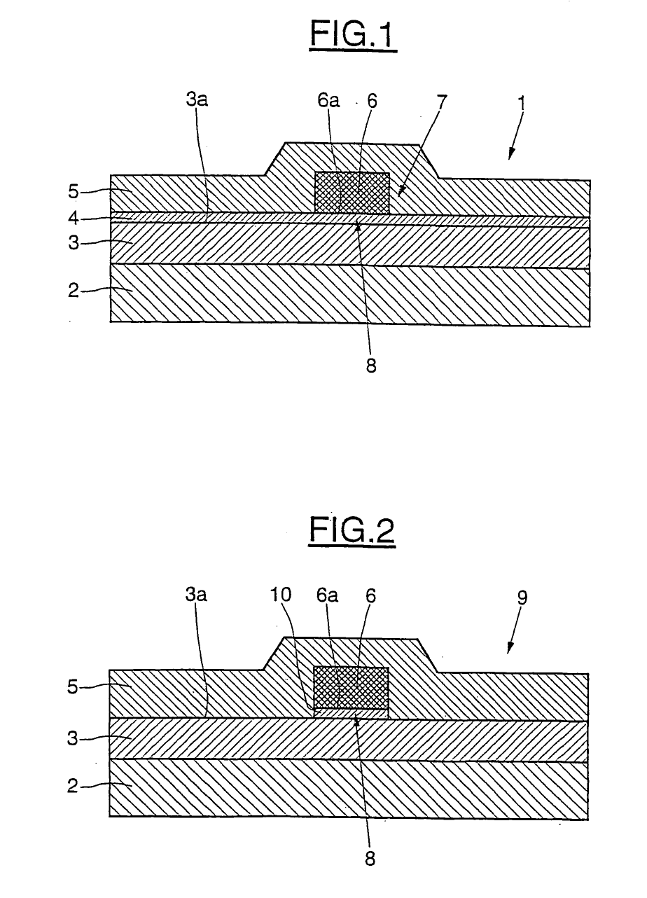

FIG. 1 shows a cross section of a first integrated optics structure according to the present invention;

FIG. 2 shows a cross section of a second integrated optics structure according to the present invention;

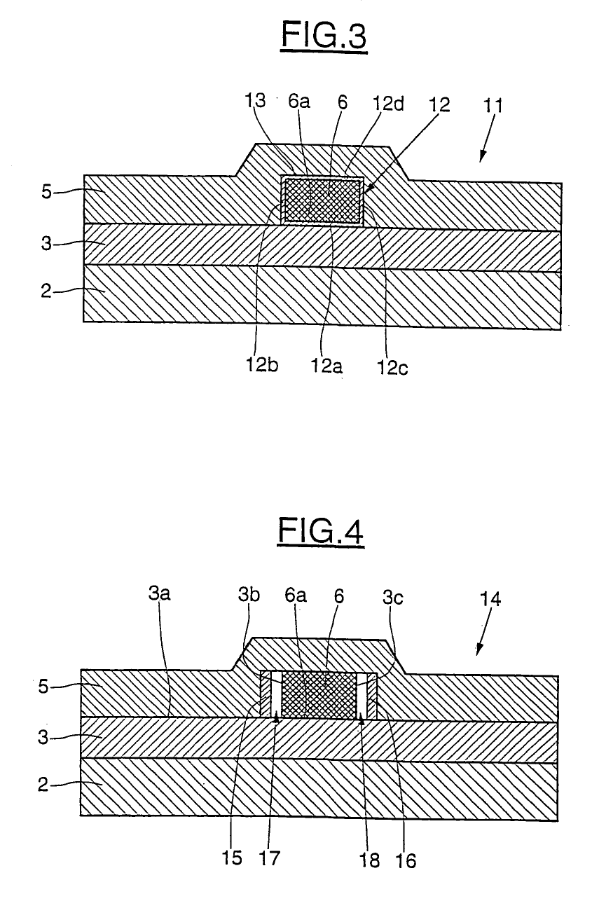

FIG. 3 shows a cross section of a third integrated optics structure according to the present invention;

FIG. 4 shows a cross section of a fourth integrated optics structure according to the present invention.

FIG. 1 shows a multilayer integrated optics structure 1 that comprises in succession, on a base wafer 2, for example made of silicon, a substrate lower layer 3, an intermediate layer 4 and a superstrate upper layer 5.

A longitudinal core 6 of an optical microguide 7 for transmitting an optical wave is formed in the upper layer 5 and on the intermediate layer 4, this transmission core 6 being of slightly rectangular cross section and being made, for example, of doped silica, of silicon nitride of silicon oxynitride.

The intermediate layer 4 thus defines a gap or spacer 8 between the lower side 6a of the transmission core 6 and the upper face 3a of the upper layer 3.

This intermediate layer is made of a material whose elasticity or deformability are greater than those of the lower layer 3 and preferably also than those of the upper layer 5. In one embodiment, the lower layer 3 and the upper layer 5 are made of undoped silica and the intermediate layer 4 is made of low-density silica.

Thus, the strains that may appear in the structure 1 during its fabrication or during its subsequent use, mainly between, on the one hand, the lower layer 3 and, on the other hand, the upper layer 5 and the transmission core 6, are capable of being at least partly absorbed by the intermediate layer 4.

As a result, the strains and/or possible deformations of the transmission core 6 may be eliminated or at the very least reduced in such a way that the light wave transmitted by the transmission core 6 does not undergo birefringence effects or does so only slightly.

Preferably, the thickness of the intermediate layer 4 is markedly less than the wavelength of the light wave transmitted by the transmission core 6.

In one embodiment, if the transmission core 6 has a width of about 6.5 microns and a thickness of about 4.5 microns, the thickness of the intermediate layer 4 may be between 0.1 microns and 0.5 microns. This thickness is compatible with the transmission of an optical wave in the transmission core, the wavelength of which is, for example, between 1.2 microns and 1.6 microns, within the range for optical telecommunication by optical fibers.

FIG. 2 shows an integrated optics structure 9 that differs from that described with reference to FIG. 1 by the fact that the intermediate layer 4 is omitted on either side of the transmission core 6 so as to leave only an intermediate strip 10 constituting a spacer between the lower face 6a of the transmission core 6 and the upper face 3a of the lower layer 3, the upper layer 5 being formed directly on the upper face 3a of the lower layer 3, on either side of the longitudinal strip 9.

FIG. 3 shows an integrated optics structure 11 in which the transmission core 6 is completely surrounded, on its four sides, by a gap 12, preferably of constant thickness. The upper layer 5 is formed directly on the upper face 3a of the lower layer 3, on either side of this gap 12.

This gap 12 is filled with a material 13 constituting a peripheral spacer, the elasticity or deformability of which are greater than those of the first layer 3 and/or the upper layer 5. In one embodiment, this material 13 may be formed by a silica aerogel.

The gap 12 may have a thickness of between 0.1 microns and 0.5 microns.

FIG. 4 shows an integrated optics structure 14 in which the lower face 6a of the transmission core 6 is in contact with the upper face 3a of the lower layer 3.

Provided on either side of the lateral sides 3b and 3c of the transmission core 6 are intermediate vertical strips 15 and 16 that are placed a certain distance from these sides so as to form gaps 17 and 18 without material.

These strips 15 and 16 have the same height as the transmission core 6, the upper layer 5 being formed on the surface 3a of the layer 3, on either side of the strips 15 and 16, and covering the transmission core 6, the gaps 17 and 18 and the upper end of the strips 15 and 16.

In one embodiment, the intermediate strips 15 and 16 are made of silica and have a thickness of between 0.25 microns and 1 micron.

In one embodiment, the gaps 15 and 16 may have a thickness of between 0.1 microns and 0.5 microns.

In general, the operations for producing the layers, the transmission core and the intermediate strips of the integrated optics structures that have just been described may be carried out by known photolithography, etching, deposition and chemical-mechanical planarization processes widely used in the microelectronics field and by the techniques for producing spacers by depositing conformal layers followed by anisotropic etching.

As regards the integrated optics structure 1 shown in FIG. 1, this may be produced in the following manner.

The lower layer 3 of undoped silica is deposited on the silicon layer 2.

The intermediate layer 4 of low-density silica is deposited by a sol-gel method.

A layer of doped silica, of silicon nitride or of silicon oxynitride is deposited and selectively etched so as to produce the transmission core 6.

Finally, the upper layer 5 of undoped silica is conformally deposited.

The process for producing the integrated optics structure 9 shown in FIG. 2 includes, in addition to the above steps for fabricating the integrated optics structure 1 shown in FIG. 1, a step of etching the intermediate layer 4, on either side of the transmission core 6 produced, so as to form the strip 10.

As regards the integrated optics structure 11 shown in FIG. 3, this may be produced in the following manner.

The lower layer 3 of undoped silica is deposited on the silicon layer 2.

A layer of silica aerogel is deposited with a thickness corresponding to the thickness of the spacer 12.

A layer of doped silica, of silicon nitride or of silicon oxynitride is deposited and selectively etched so as to produce the transmission core 6.

The layer of silica aerogel is etched, on either side of the transmission core 6, so as to form the part 12a of the spacer 12 located between the lower layer 3 and the transmission core 6.

A conformal layer of silicon aerogel is deposited with a thickness corresponding to the thickness of the spacer 12. This layer is selectively etched so as to leave only the lateral parts 12b and 12c and the upper part 12d of the spacer 12 on the lateral faces and on the upper face of the transmission core 6.

Finally, the upper layer 5 of undoped silica is conformally deposited.

As regards the integrated optics structure 14 shown in FIG. 4, this may be produced in the following manner.

The lower layer 3 of undoped silica is deposited on the silicon layer 2.

A layer of doped silica, of silicon nitride or of silicon oxynitride is deposited and etched so as to produce the transmission core 6.

An intermediate layer, for example made of silicon, is conformally deposited with a thickness equal to the thickness of the gaps 17 and 18 to be obtained. This layer is selectively etched so as to leave only the material corresponding to the gaps 17 and 18.

A layer of undoped silica is conformally deposited with a thickness corresponding to the thickness of the intermediate strips 15 and 16 to be obtained. This layer is etched so as to leave only the intermediate strips 15 and 16.

The intermediate material filling the gaps 17 and 18 are selectively etched so that these gaps no longer contain material.

Finally, the upper layer 5 of undoped silica is conformally deposited. Because of the narrowness of the gaps 17 and 18, there is little or no penetration by the material forming the upper layer 5 into these gaps.

The present invention is not limited to the examples described above. In particular, it is conceivable to combine the solutions proposed.

1. A multilayer integrated optics structure which comprises at least one integrated optics microguide having an integrated core for the transmission of at least one light wave, characterized in that a gap (8, 12, 17) runs along said transmission core (6) and at least partly surrounds its periphery.

2. The structure as claimed in claim 1, characterized in that said gap (12) completely surrounds said transmission core.

3. The structure as claimed in either of claims 1 and 2, characterized in that said gap is at least partly filled with a material (4, 13, 19) whose elasticity or deformability are greater than those of the layer or layers adjacent said transmission core.

4. The structure as claimed in any one of the preceding claims, characterized in that said transmission core is produced on an intermediate layer (4, 10) and in a following layer (5), this intermediate layer (4, 10) exhibiting greater elasticity or deformability than this following layer and/or the layer on which it is formed.

5. The structure as claimed in any one of the preceding claims, characterized in that said transmission core is produced between two layers (3, 5) and on one of these layers and that a strip (8) exhibiting greater elasticity or deformability than at least one of these layers is interposed between one of these layers and the transmission core.

6. The structure as claimed in any one of the preceding claims, characterized in that said gap is left between at least one intermediate strip (15) and said transmission core (6).

7. The structure as claimed in claim 6, characterized in that said intermediate strip (15) is produced laterally to said transmission core.

8. The structure as claimed in any one of the preceding claims, characterized in that the thickness of said gap (8, 12, 17) is less than the wavelength of the light wave transmitted via said transmission core.

9. The structure as claimed in any one of the preceding claims, characterized in that said transmission core (6) is of rectangular cross section, said gap (8, 12, 17) extending along at least one of its sides.
